(19) United States
(12) Patent Application Publication
(10) Pub. No.: US 2004/0124735 A1
(43) Pub. Date: Jul. 1, 2004

(54) Cooling fan structure

(76) Inventor: Cheng-Fang Hsiao, Hsichih City (TW)

Correspondence Address: John S. Egbert, Harrison & Egbert, 7th Floor, 412 Main Street, Houston, TX, 77002, US

(21) Appl. No.: 10/687,141

(22) Filed: Oct. 17, 2003

(30) Foreign Application Priority Data
Dec. 27, 2002 (CN) 02294185.1

(51) Int. Cl. H02K 9/00; H02K 9/06; H02K 7/00

(52) U.S. Cl. 310/257; 310/67 R; 310/62; 310/164

(57) ABSTRACT

A cooling fan structure comprises a base in which a ring stator is mounted. The ring stator is provided with polar claws which are bent to form in the inner side of the ring stator. A plurality of blades are pivotally mounted in a receiving space of the ring stator such that the blades are circumvented by a connection ring. A magnetic ring rotor is fastened with the connection ring and is induced by a coil of the ring stator to drive the blades, thereby improving the driving torque, the ventilation area, and the winding.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a cooling device, and more particularly to a cooling fan structure having a greater driving torque and ventilation area, as well as a simplified winding.

### BACKGROUND OF THE INVENTION

As shown in FIGS. 1-3, a cooling fan structure of the prior art comprises a base 11, a stator 12, a rotor seat 17, and a plurality of blades 16. The stator 12 is mounted in the center of the base 11 and is formed of a plurality of coils 13 and pole bars 14. The rotor seat 17 is provided in the inner edge with a magnetic ring rotor 18, which is induced by the coils 13 of the stator 12, so as to drive the blades 16. This prior art cooling fan structure is defective in design in that the winding of the coils 13 is difficult and time-consuming, and that the rejection rate of the product is relatively high.

As shown in FIGS. 4-6, another prior art cooling fan structure comprises a base 21, a stator 22, a plurality of blades 26, and a rotor seat 27. The stator 22 is mounted in the center of the base 21 and is formed of a coil 23 which is mounted along with an upper pole piece 24 and a lower pole piece 25, and in conjunction with a magnetically permeable tube 29. The rotor seat 27 is provided in the inner edge with a magnetic ring rotor 28, which is induced by the coil 23 of the stator 22 to drive the blades 26. The coil 23 is susceptible to damage in the process of mounting the upper pole piece 24 and the lower pole piece 25, thereby resulting in high rate of product rejection.

As shown in FIG. 3, the rotor seat 17 of the first prior art cooling fan structure is large in volume at the expense of the ventilation efficiency of the cooling fan structure. In another words, the ventilation area of the first prior art cooling fan structure is unduly limited. Similarly, the rotor seat 27 of the second prior art cooling fan structure is so sized that the ventilation area of the structure is unduly limited.

### BRIEF SUMMARY OF THE INVENTION

The primary objective of the present invention is to provide a cooling fan structure with a simplified winding and a substantial reduction in volume of a rotor seat, thereby resulting in an enhancement of blade driving torque and a substantial increase in ventilation area of the structure.

In keeping with the principle of the present invention, the foregoing objective of the present invention is attained by a cooling fan structure comprising a base, a ring stator, a magnetic ring rotor, a connection ring, and a plurality of blades. The ring stator is mounted in the base such that the polar claws of the ring stator are arranged along the inner side of the ring stator. The blades are pivotally mounted in the receiving space of the ring stator such that the blades are circumvented by the connection ring to which the magnetic ring rotor is fastened. The magnetic ring rotor is induced by a coil of the ring stator to drive the blades.

The features, functions, and advantages of the present invention will be more readily understood upon a thoughtful deliberation of the following detailed description of two preferred embodiments of the present invention with reference to the accompanying drawings.

### BRIEF DESCRIPTION OF THE SEVERAL VIEWS OF THE DRAWINGS

FIG. 1 shows an exploded view of a cooling fan structure of the prior art.

FIG. 2 shows a top plan view of the prior art cooling fan structure in combination.

FIG. 3 shows a sectional schematic view of the prior art cooling fan structure as shown in FIG. 2.

FIG. 4 shows an exploded view of another prior art cooling fan structure.

FIG. 5 shows a top plan view of the another prior art cooling fan structure in combination.

FIG. 6 shows a sectional schematic view of the another prior art cooling fan structure as shown in FIG. 5.

FIG. 7 shows a perspective view of a first preferred embodiment of the present invention.

FIG. 8 shows an exploded view of the first preferred embodiment of the present invention.

FIG. 9 shows a top plan view of the first preferred embodiment of the present invention as shown in FIG. 7.

FIG. 10 shows a sectional schematic view of the first preferred embodiment of the present invention as shown in FIG. 7.

FIG. 11 shows an exploded view of a second preferred embodiment of the present invention.

FIG. 12 shows a sectional schematic view of the second preferred embodiment of the present invention in combination.

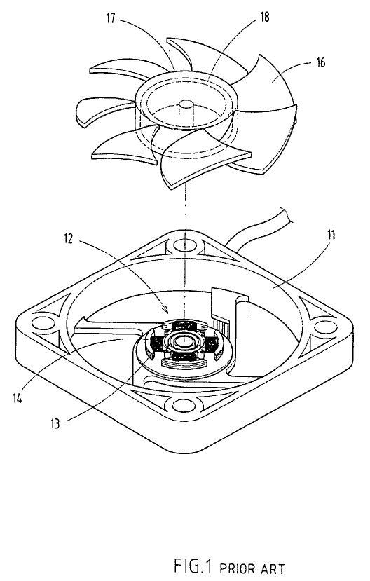

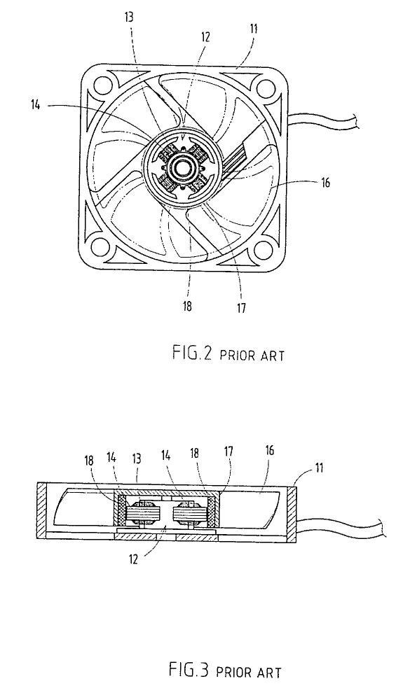

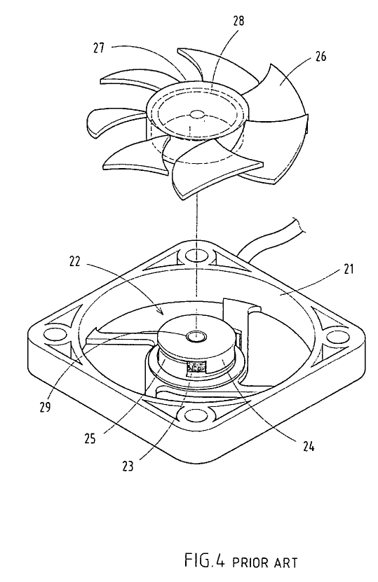

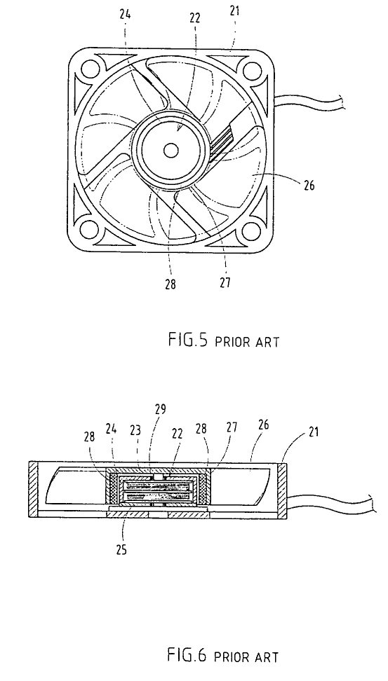

### DETAILED DESCRIPTION OF THE INVENTION

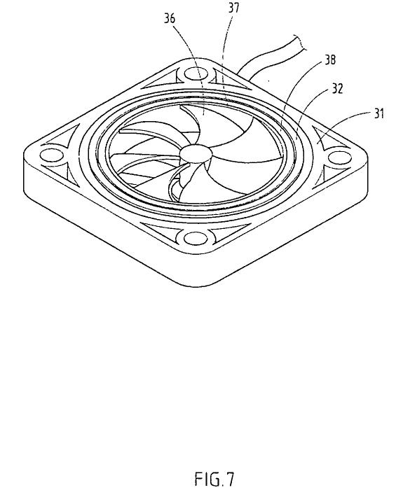

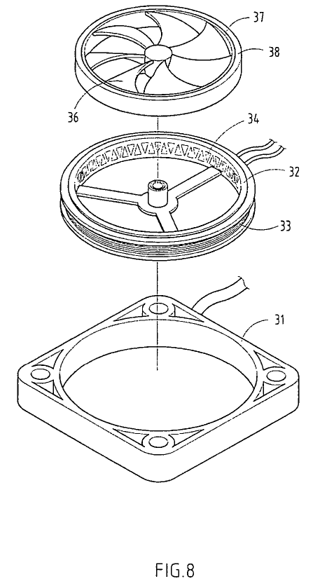

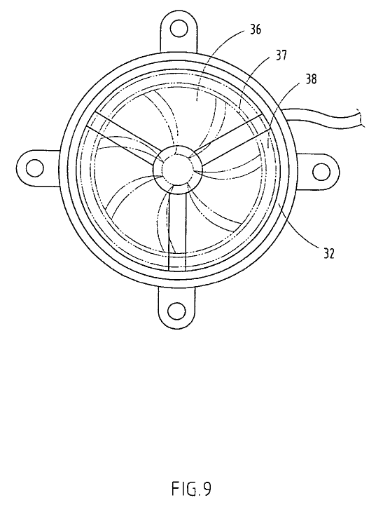

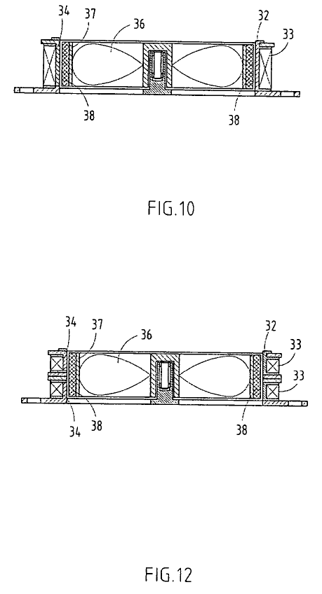

As shown in FIGS. 7-10, a cooling fan structure embodied in the present invention comprises a base 31, a ring stator 32, a plurality of blades 36, a connection ring 37, and a magnetic ring rotor 38.

The ring stator 32 is mounted in the base 31 and is formed of one set of coil 33, and one set of polar claws 34 which are so bent as to arranged along the inner edge of the ring stator 32.

The blades 36 are pivotally mounted in a receiving space of the ring stator 32 such that the blades 36 are circumvented by the connection ring 37 to which the magnetic ring rotor 38 is fastened. The magnetic ring rotor 38 is induced by the coil 33 to drive the blades 36.

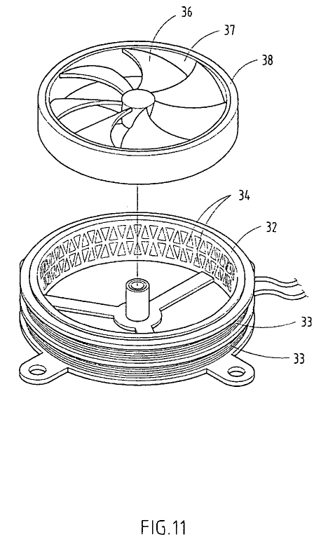

As shown in FIGS. 11 and 12, a cooling fan structure of the second preferred embodiment of the present invention is basically similar in construction to that of the first preferred embodiment described above, with the difference being that the former comprises a ring stator 32 which is formed of two sets of coils 33 and two sets of polar claws 34. In light of the alternate layout of phase, the operating stability of the structure of the present invention is enhanced. In addition, the operating dead point of the structure of the present invention is eliminated. The polar claws 34 of the ring stator 32 are insulated by the plastic material to facilitate the winding of the coils 33.

The advantages of the present invention over the prior art counterparts are thus readily apparent. In light of the ring stator 32 being directly mounted in the inner edge of the base 31 and the polar claws 34 being bent to form in the inner side of the ring stator 32, the coil 33 can be wound directly on the ring stator 32. The insulation of the polar claws 34 enhances the assembling efficiency and the winding efficiency of the present invention, thereby reducing the rejection rate of the product. An increase in the layout set of the polar claws 34 enhances the operating stability of the structure of the present invention. The alternate layout of a plurality of ring stators 32 and coils 33 results in an increase in operational phase so as to eliminate the operating dead point of the structure. The ventilation area of the structure of the present invention is greatly enlarged by virtue of the magnetic ring rotor 38 being mounted on the connection ring 37 to minimize the size of the rotor seat. The blade turbulence is reduced by the magnetic ring rotor 38 and the connection ring 37.

The embodiments of the present invention described above are to be regarded in all respects as being illustrative and nonrestrictive. Accordingly, the present invention may be embodied in other specific forms without deviating from the spirit thereof. The present invention is therefore to be limited only by the scope of the following claims.

1. (Currently amended) A cooling fan structure comprising:
a base;
a ring stator mounted in said base;
a series of polar claws being bent to form in an inner side of said ring stator;
a plurality of blades mounted pivotally in a receiving space of said ring stator;
a connection ring circumventing said blades; and
a magnetic ring rotor fastened with to said connection ring such that said magnetic ring rotor is induced by a coil of said ring stator to drive said blades.

2. (Currently amended) The cooling fan structure as defined in claim 1, wherein said ring stator is provided with comprised of two or more sets of polar claws.

3. (Currently amended) The cooling fan structure as defined in claim 1, wherein said ring stator is provided with comprised of an upper coil set and a lower coil set, so as to arrange two sets of ring stator stators in an alternate manner.

4. (Original) The cooling fan structure as defined in claim 1, wherein said polar claws of said ring stator are insulated by a plastic material.
